(19) United States
(12) Patent Application Publication
(10) Pub. No.: US 2010/0272305 A1
(43) Pub. Date: Oct. 28, 2010

(54) HEADSET WITH EARPHONES

(75) Inventor: Robert G. Pedersen, II, Salt Lake City, UT (US)

Correspondence Address: Workman Nydegger;1000 Eagle Gate Tower, 60 East South Temple, Salt Lake City, UT, 84111, US

(73) Assignee: ZAGG, INC., Salt Lake City, UT (US)

(21) Appl. No.: 12/650,976

(22) Filed: Dec. 31, 2009

Related U.S. Application Data
(63) Continuation of application No. 29/330,227, filed on Dec. 31, 2008, now Pat. No. D607875.
(60) Provisional application No. 61/143,664, filed on Jan. 9, 2009.

(51) Int. Cl. H04R 25/00

(52) U.S. Cl. 381/377

(57) ABSTRACT

A headset including a cord having a plug on a first end and a first lead cord and a second lead cord on a second end, wherein the first lead cord is connected to a first speaker and the second lead cord is connected to a second speaker, a plurality of sliders, each slider having an opening formed therein, wherein the first and second lead cords each pass through each of the plurality of sliders, wherein a position of each slider is adjustable along a length of the first and second lead cords.

### CROSS-REFERENCE TO RELATED APPLICATION

This application claims the benefit of U.S. Provisional Patent application Ser. No. 61/143,664, filed on Jan. 9, 2009, and is a continuation of U.S. Design Patent application Ser. No. 29/330,227, filed on Dec. 31, 2008, which are both incorporated herein by reference in their entirety.

### BACKGROUND OF THE INVENTION

1. The Field of the Invention

The present invention generally relates to headsets or earphones. More particularly, the present invention relates to headsets which improve the wear-ability and durability of the headsets by providing an anchoring means by which the headsets may be more securely attached to a user during use.

2. The Relevant Technology

With the increased popularity of cellular phones and mobile music players, there has been an increase in the number of headsets, earphones, and earbuds that are available for use in association with the various electronic devices. Although various advances have been made for increasing the durability of the electronic devices themselves, including advances in the designs of various covers and casings for improving the durability of the devices, many headsets which are currently used in the art remain vulnerable to problems such as tangling, falling or being pulled from of the user's ears during use and being subsequently dragged, and the like. These problems can result in pain to the user and damage to the headset, and may require a user to periodically replace the headsets as they become unusable, resulting in increased expense and customer dissatisfaction.

### BRIEF DESCRIPTION OF THE INVENTION

Embodiments of the invention relate to a headset that cab be used with any device that has an audio output, video output, and the like or any combination thereof. The headset can also be referred to as earphones, ear buds, headphones, and the like. In some embodiments, a headset is an apparatus that can be worn by a user and connected to a device. In one example, the headset allows a user to listen and/or watch a video on an mp3 player such as an ipod.

One aspect of the invention includes a headset which may be used to anchor the speakers and headset to a user during use. The headset includes a cord having a plug on a first end and a first lead cord and a second lead cord on a second end, wherein the first lead cord is connected to a first speaker and the second lead cord is connected to a second speaker, and a plurality of sliders that may be installed during or after manufacture, each slider having an opening formed therein, wherein the first and second lead cords each pass through each of the plurality of sliders, wherein a position of each slider is adjustable along a length of the first and second lead cords. In some examples, the sliders can also pass to the cord portion of the headset.

A second aspect of the invention comprises a series of adaptor sliders which may be installed on a headset after the headset has been manufactured. The adaptor set includes a plurality of sliders, each slider having an enclosing portion with an opening formed therein, each slider being capable of being installed so as to enclose the first and second lead cords in the opening portion of the enclosing portion so that the first and second lead cords pass through each of the plurality of sliders, wherein a position of each slider is installable and adjustable along a length of the first and second lead cords. One advantage of the adaptor set is that it provides owners of existing headsets with the ability to anchor their headsets to themselves during use without requiring the users to purchase an entirely new headset with anchoring capabilities.

A third aspect of the invention is a kit for anchoring the headset of an electronic device to a user. The kid includes a plurality of sliders, each slider having an enclosing portion with an opening formed therein, each slider being capable of being installed on a headset including a plug, a first and second lead cord attached to the plug, and a first and second speaker attached to the first and second lead cord, respectively, each slider being capable of being installed by a user so as to enclose the first and second lead cords in the opening portion so that the first and second lead cords pass through each of the plurality of sliders, wherein a position of each slider is installable and adjustable along the length of the first and second lead cords, a user instruction, including instructions on how to install the plurality of sliders and instructions on how to position the plurality of sliders and headset on a user so as to anchor the headset to a user during use, and a package having at least one enclosure for enclosing the plurality of sliders and the user instruction.

### BRIEF DESCRIPTION OF THE DRAWINGS

To further clarify the advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a perspective view of an exemplary headset;

FIG. 2 illustrates a top view of the headset illustrated in FIG. 1;

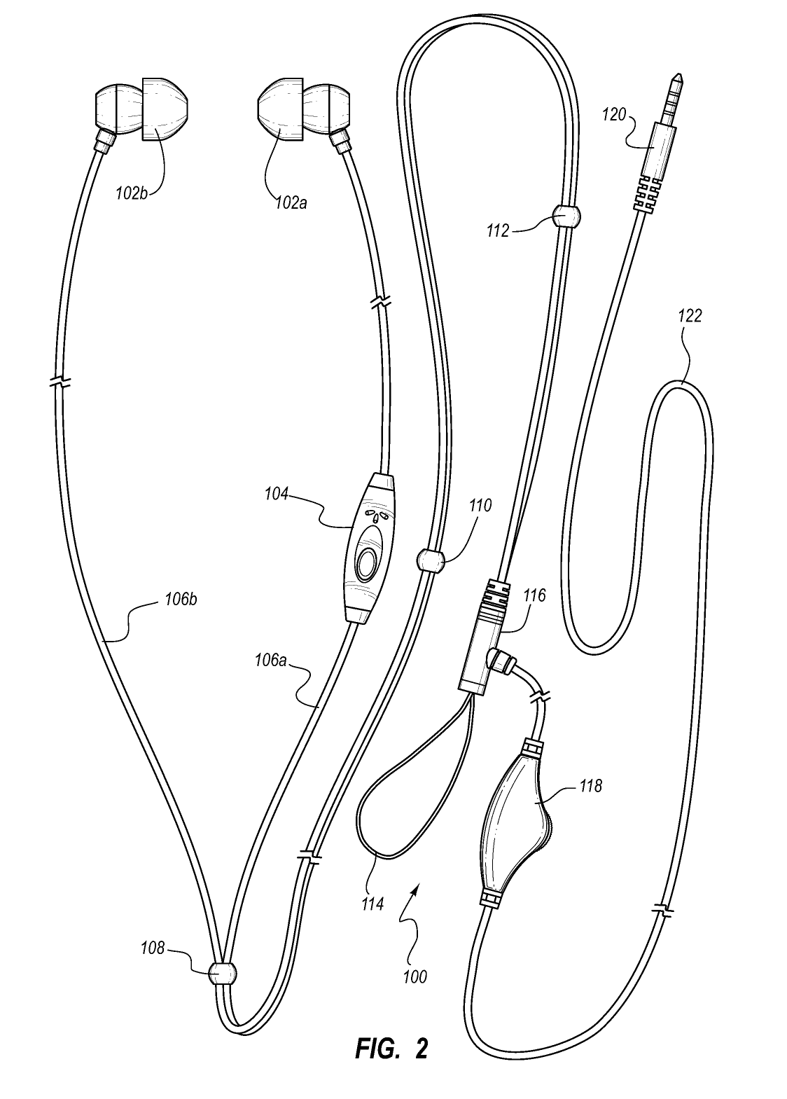

FIGS. 3A-3C illustrate a series of examples of the headset including sliders that can be used to adjust how the headset is worn or that can impact the wear-ability of the headset;

FIGS. 4A-4C illustrate a series of examples of the headset including sliders that can be used to adjust how the headset is worn or that can impact the wear-ability of the headset;

FIG. 5 illustrates an alternative embodiment of the invention wherein the sliders may be installed on an existing headset after manufacturing as part of an adaptor kit.

### DETAILED DESCRIPTION OF THE PREFERRED EMBODIMENTS

Embodiments of the invention relate to a headset that can be used with any device that has an audio output, video output, or the like or any combination thereof. The headset can also be referred to as earphones, ear buds, headphones, and the like. In some embodiments, a headset is an apparatus that can be worn by a user and connected to a device. In one example, the headset allows a user to listen and/or watch a video on an mp3 player such as an ipod.

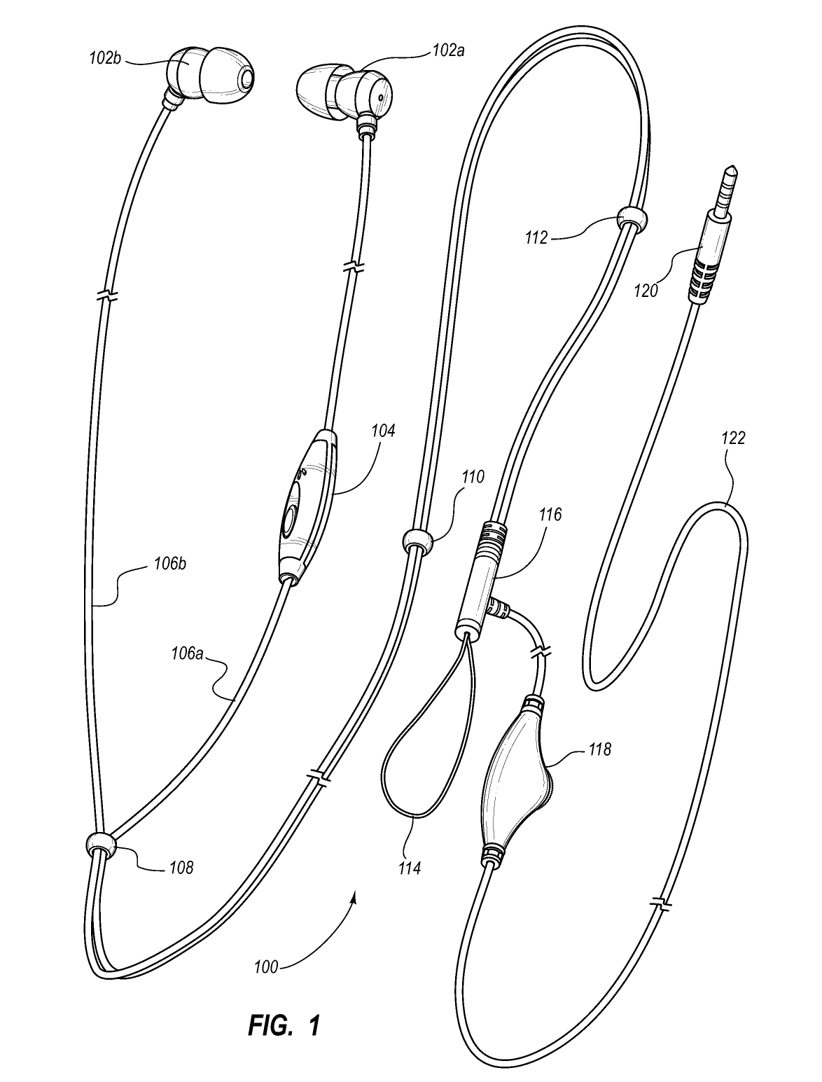

FIG. 1 illustrates a perspective view of a headset 100. In general, a headset 100 includes speakers 102a and 102b (collectively speakers 102), a cord 122, and a plug 120. The speakers 102 (or earphones in some instances) are typically situated or oriented near, next to, or within a user's ear. The speakers 102 then render an electric signal from the device connected to the headset 100 via the plug 120 into an audible signal which for the user's use or enjoyment.

The plug 120 is typically formed to be inserted into a device such as, by way of example only and not limitation, a computer, a personal music/video player (e.g., ipod), a personal digital assistant, a cellular telephone, or any other device having the appropriate output port. The plug 120 is connected to the speakers 102 via a cord 122 that carries electrical signals from the plug 120 to the speakers 102a and 102b.

In this example, the headset 100 also includes a microphone/controller 104. The microphone/controller 104 allows a user to answer calls and/or control a series of operations on the connected device. This allows the mode or usage of the device to switch, by way of example only, from a cellular telephone to an mp3 player (like an iphone). Thus, a user may use the microphone/controller 104 of the headset 100 to operate a series of functions on the device, such as controlling the playback of music of a mp3 player of the device, while listening to music via the speakers of the headset 100. Then, upon receiving an incoming call, the user may use the microphone/controller 104 to pause the playback of music on the mp3 player of the device and answer the incoming call. Then the user may use the speakers of the headset 100 and the microphone of the microphone/controller 104 to communicate during the incoming call.

The headset 100, in this example, also includes a loop 114. The loop 114 can be looped or connected with a button on a user's shirt, by way of example, to prevent the cord 122 from dangling and becoming tangled or damaged during use. In one embodiment, the loop 114 is also removable and is attached to the cord 122 via the casing 116.

In this example, the casing 116 also serves as a location to separate the cord 122, which includes an electronic connection from the plug 120 for each of the speakers 102a and 102b, into separate leads or cords 106a and 106b, where each cord 106a and 106b includes an electronic connection from the plug to the respective speaker 102a and 102b. Thus, the cords 106a and 106b connect, respectively to speakers 102a and 102b, and are combined into a single cord 122 (which includes both the lead cords 102a and 102b). In one embodiment, the single cord 122 and cords 106a and 106b have an insulating nylon layer to eliminate or reduce tangling and other problems that occur with conventional plastic coverings that are currently used to cover cords.

The length of the cord 122 and of the lead cords 102a and 102b can vary during manufacture or, in some embodiments, may include a length adjuster. In addition, the length of cord between components (e.g., distance from speaker 102a to microphone/controller 104) can change at the time of manufacture, depending on the specific requirements of the headset 100 and its intended device. The cord 122 may also carry video signals that are delivered to a video device along with audio. The plug may also be embodied to have different form factors such that it can carry multiple signals in the cord 122. One of skill in the art can appreciate that different devices have different form factors and embodiments of the invention contemplate these form factors of plugs or other connectors.

The headset 100 also includes a plurality of beads or sliders that are shown, in this example as sliders 108, 110, and 112. The actual number of sliders can be less than three or more than three on any given embodiment. As described more fully below, one advantage of using the sliders 108, 110, and 112, is that it is possible to more accurately control the placement of the headset 100 during use. More specifically, the sliders 108, 110, and 112 enable a user to secure the headset 100 so that the headset 100 is more securely anchored to the user. As such, the speakers 102 are is less likely to fall or be pulled from the user's ears during use and the cords 122, 106a, and 106b are less likely to become tangled or damaged.

This is unlike the configurations currently known in the art, where the only points where the headset is anchored is at the plug, where the headset is attached to the device, and the speakers, where the headset is anchored to the user's ears. Thus, in these configurations, the headset is anchored only at the ends of the headset at the plug and speakers, with the connecting components being free to move. Unfortunately, the connecting cords often get tangled or caught during use, often causing the plug to be disconnected from the device or the speakers to be pulled from the user's ears. This can result in pain to the user as the speakers are pulled from the user's ears and/or damage to the headset as the electrical leads in the cords become damaged and the speakers become electronically disconnected from the plug. As described below, by using the sliders 108, 110, and 112, a user of the headset 100 may create various cord configurations in order to reliably anchor the headset 100 to the user during use, so as to prevent such damage to the headset 100.

In this example, the sliders 108, 110, and 112 are disposed around the cords 102a and 102b and are used to create junction points where the separate cords 106a and 106b are held together. These points may be moved by sliding the sliders 108, 110, and 112 along the cords 106a and 106b to various positions along the cords 102a and 102b. This feature of moving the sliders 108, 110, and 112 to various positions can aid in the wear-ability of the headset 100 and also assists in providing various anchors to prevent either damage to the headset 100 and/or pain to the user. One of skill in the art can appreciate that the microphone/controller 104, loop 114, casing 116, volume controller 118, are optional. In one embodiment, the casing 116 identifies a point where the cord 122 splits into the cords 106a and 106b.

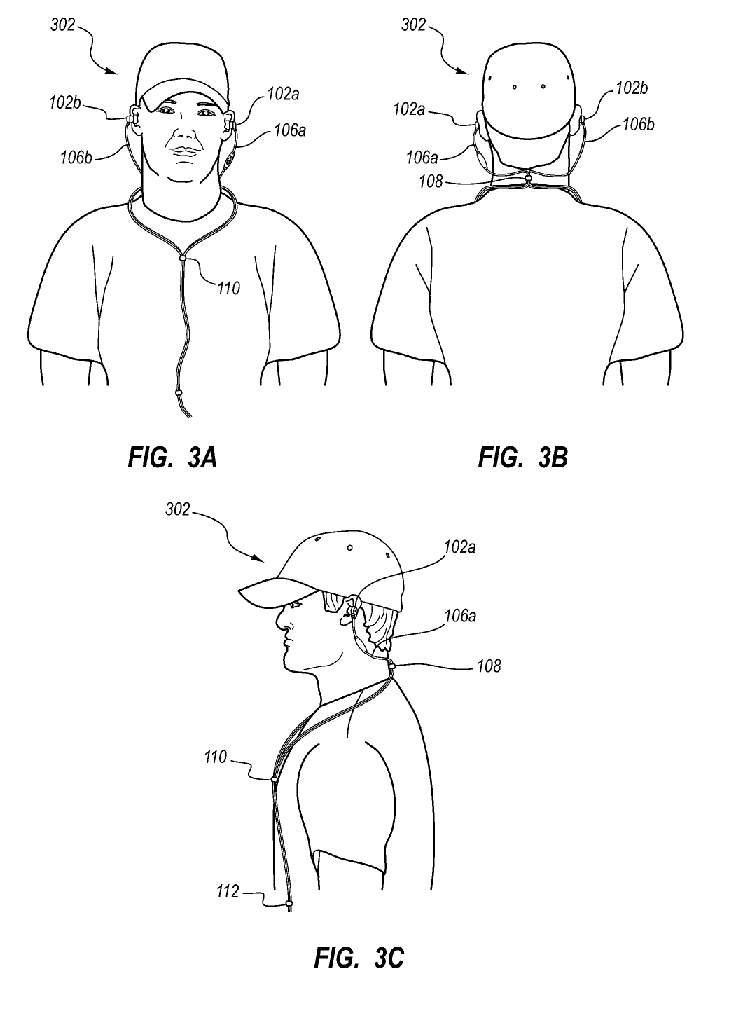

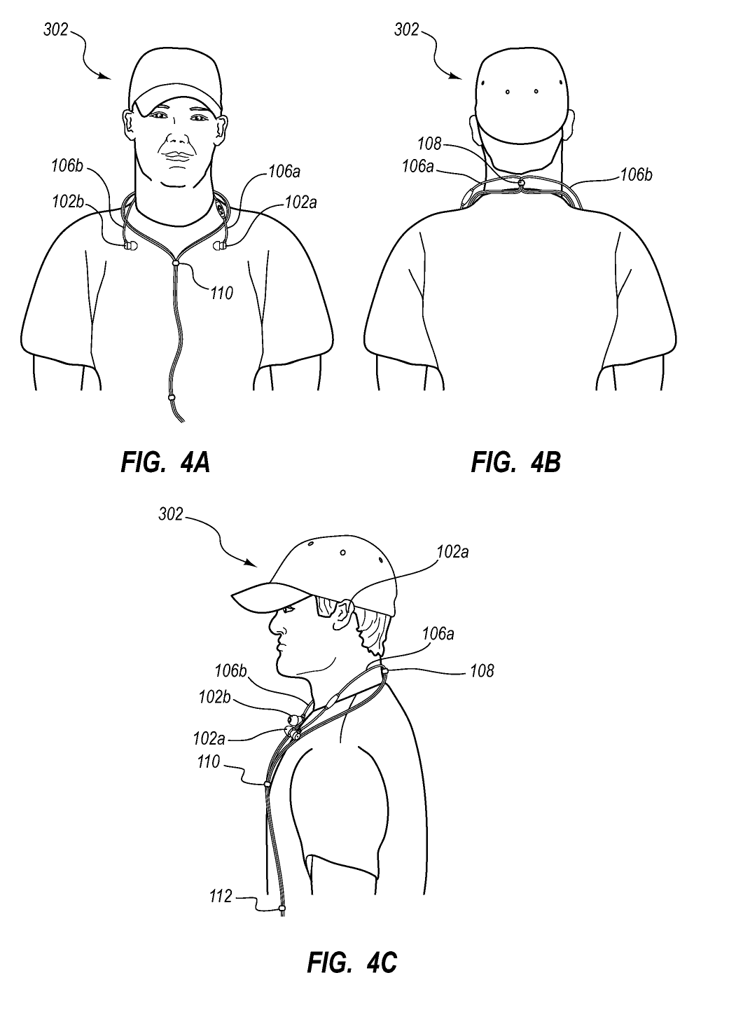

FIGS. 3A-3C and 4A-4C illustrate a configuration of sliders 108, 110, and 112 which may be placed so as to anchor the headset to the user and to prevent the speakers 102a and 102b and cords 106a and 106b from becoming tangled or damaged. FIGS. 3A-3C illustrate an example where a user 302 is wearing the headset 100. The user 302 has the speakers 102a and 102b in his ears. FIG. 3A illustrates the front of the user 302, FIG. 3B is a illustrates the back of the user 302, and FIG. 3C is a perspective or side view of the user 302. As shown in FIG. 3B, the slider 108 is positioned at the back of the user's neck so as anchor the speakers 102a and 102b and limit the freedom of the upper portion of the cords 106a and 106b. In FIG. 3A, the user is looking out of the FIG. 3A and the slider 110 is shown resting on the chest area of the user 302. The slider 110 can be positioned up or down on the cords 106a and 106b per the user's desire or convenience. The slider 112 (or additional sliders below the slider 110 in the direction of the plug 120) can be used to keep the cords 102a and 102b together.

Because the sliders 108, 110, and 112 are capable of sliding along the cords 106a and 106b, the user 302 may easily configure the sliders into the configuration shown in FIGS. 3A-3C by moving slider 110 until it is located adjacent to slider 112, or adjacent to the casing 116. Then, the user 302 may simply separate the cords 106a and 106b in the area between slider 108 and slider 110 and move his or her head through the resulting loop so that the slider 110 is positioned in front of the user's head, the slider 108 is positioned behind the user's head and the two cords 106a and 106b between the two sliders 108 and 110 are positioned on each side of the user's head. Then the sliders 108 and 110 may be repositioned in order to create a fit that is comfortable to the user 302.

As shown in FIG. 3C, this configuration provides an anchor that can prevent the speakers 102a and 102b from being pulled out of the user's ears. Any force on the cord is effectively stopped or reduced by at least the slider 108. The speakers 102a and 102b can then be placed in the ear of the user in accordance with the user's desires. For example, a force on the headset at, for example, any part of the headset below the slider 108 may not pull the speakers from the ears of the user 302 because the slider 108 prevents effectively counteracts this force.

In addition, because the slider 108 is movable, the length of the cords 102 from the slider 108 to the speakers can be adjusted to accommodate the user's preferences. As shown in FIG. 4A-4C, another advantage of the sliders is that when the speakers 102a and 102b are removed from the user's ears, the speakers 102a and 102b can then rest on the user's shoulders without dangling from the device. In this example, the sliders 108 and 110 work together to wrap the cords 102 around the user's neck and then effectively hold the cords 106 or 122 in place regardless of whether the speakers 102a and 102b are inserted into the user's ears or not. Advantageously, this arrangement allows a user to remove the speakers 102a and 102b without having to wind them up or put them somewhere.

This may have advantages in a variety of situations, such as when a user is traveling on a plane, and has been instructed to remove the headset during the emergency flight instructions at the beginning of the flight. In conventional systems, once the user has removed the speakers 102a and 102b from his or her ears, they have to stow the headset somewhere until the conclusion of the emergency flight instructions. For example, when traveling on a plane, a user that removes conventional speakers has to put them somewhere. The user may sit on them or have to stow them for various reasons. In contrast, the slides 108 and 110, at least, allow the user to simply remove the speakers from the user's ears. If wanted, the user can also unplug the headset from the device. In this case, the sliders 108 and 110 keep the headset in place, and allow for the headset to be continuously connected or reconnected to the device and the speakers inserted with minimal effort and without having to readjust the cord in any manner. In one example, the user simply lifts the speakers from his or her shoulders and insert's them into his or her ears.

The sliders 108, 110, and 112 each have an opening that allows the cords 102 to pass therethrough. Typically, the opening in each slider is configured with sufficient friction between the cords 102 and the sliders 108, 110, and 112 to prevent the sliders 108, 110, and 112 from moving inadvertently. In other words, the user typically has to exert some type of force to move the sliders 108, 110, and 112. This ensures that the sliders 108, 110, and 112, once positioned by the user, tend to stay in the set locations in accordance with the user's preferences.

As shown in FIGS. 3A-3C and FIGS. 4A-4C, the cord 106 is typically arranged so that it branches out of each end of the slider 108, when the slider 108 is positioned at the back of the neck. The cord branches, for example, because the user places his or her head between the cord 106a and 106b in an opening formed between the sliders 108 and 110, as shown in FIGS. 3A-3C and FIGS. 4A-4C. Also, the cords 106a and 106b, at the other end of the opening the slider 108, go to different ears, thereby forming the branch. FIGS. 4B and 4C illustrate that the cord branches at both sides of the opening on the slider 108. The branching of the cords 102a and 102b provide additional stability that prevent the speakers 102a and 102b from being yanked or pulled our of the user's ears. In other words, the branched cords 106a and 106b make it considerably more difficult to move the slider 108 along the length of the cords 106a and 106b. As a result, the slider 108 tends to stay in the same position during use of the headset 100. As previously noted, some force is typically required to move the sliders even when the cord does not branch. As previously discussed, this friction ensures that the sliders 108, 110, and 112 stay in their intended positions on the cords 106a and 106b. The branching of the cords at the slider 108 provide additional strength to maintain the speakers in the user's ears.

In one embodiment, the loop 114 can also provide an anchor to keep at least some of the cord 102 in a particular position or to constrain movement of the cord 122.

Although in the previous description, the sliders 108, 110, and 112 are each capable of sliding along the cords 106a and 106b, in an alternative embodiment of the invention, one or more of the sliders 108, 110, and 112 may be anchored into place, rather than being capable of sliding. For example, the slider 108 may be anchored into place at a location so as to enable the wearing configuration shown in FIGS. 3A-3C and 4A-4C, while preventing the range of cord 106a and 106b on which the slider 110 may slide. Similarly, the slider 112 may be anchored in addition to or instead of the slider 108. Furthermore, in configurations where more or less than three sliders are used, any number of the sliders may be permanently anchored or attached to the cords 106a and 106b without departing from the meaning or scope of the claims recited below.

In one embodiment, the slider 108 may be permanent and unable to slide. When the headset is worn as illustrated in FIGS. 3A-4C, the permanent slider 108 can prevent the speakers from being inadvertently removed from the ears of the user 302 when the cord is pulled or caught on something.

In another example, the slider 110 and/or the slider 108 may also be permanent. The cords between the sliders 108 and 110 are separated sufficiently and have enough separation in terms of cord length to allow a user to slip his or her head through this opening, as illustrated in FIGS. 3A-4C. Thus, embodiments of the invention contemplate instances where all of the sliders are moveable, some of the sliders are moveable, and none of the sliders are moveable. Further, embodiments of the invention contemplate headsets with two sliders or beads, which may be moveable and/or permanently placed. The sliders can be integrally formed with the cords or placed at a later time. The sliders, which typically have an opening that is smaller than the plug or the speakers are placed on the cord during manufacture and may not be removed unless broken.

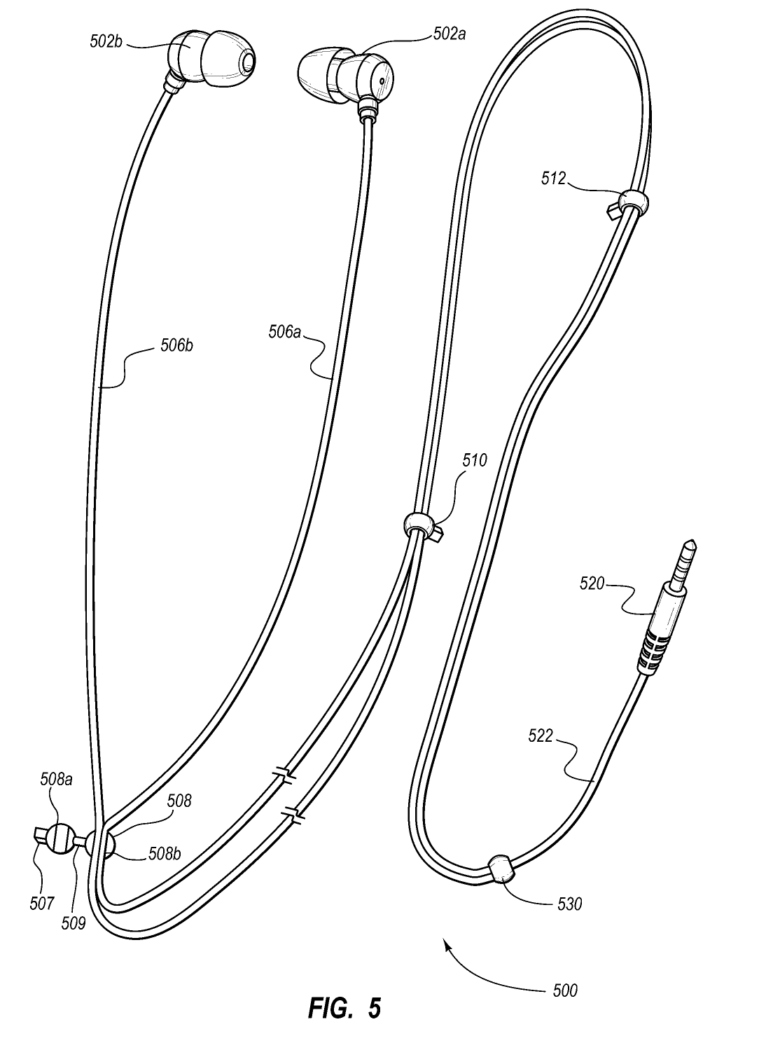

In addition, other configurations may be used. For example, in an alternative embodiment of the invention shown in FIG. 5, the adaptor sliders 508, 510, and 512 comprise a series of clamshell-shaped which may be used in an adaptor kit which may be used in association with a headset 500 currently known in the art. In this example, the headset 500 includes a plug 520, a cord 522, which divides into two separate cords 506a and 506b at a junction point 530. The cords 506a and 506b connect the plug 520 to two separate speakers 502a and 502b. The junction point 530 may not be a slider, but can be fashioned as is known in the art where the cord 522 is separated into the cords 506a and 506b.

As described above, one disadvantage of the headset 500 is that the cords 522, 506a and 506b may become tangled or caught on something during use and consequently damaged. In order to alleviate this difficulty, the user may purchase an adaptor kit which includes a series of adaptor sliders 508, 510, and 512 which may be placed on the cords 506a and 506b in order to provide some of the anchoring benefits of the first embodiment of the invention. In this example, the adaptor sliders 510 and 512 are shown as being closed and fully installed on the cords 506a and 506b of the headset 500, whereas the adaptor slider 508 is shown in an open state, during the installation process.

Although any number of configurations of adaptor sliders 508, 510, and 512 may be used, so long as the adaptor sliders 508, 510, and 512 are capable of being installed on the headset 500 after the headset 500 has been manufactured, the adaptor sliders 508, 510, and 512 shown in FIG. 5 comprise clamshell-shaped beads. More specifically, the adaptor sliders 508 comprise clamshell-shaped beads, wherein the bead includes a first half 508a and a second half 508b, each of which has a hollow portion capable of housing a portion of the cords 506a and 506b, such that when the first half 508a and second half 508b are joined together, both the cords 506a and 506b may be slideably disposed in the hollow portions of the first half 508a and second half 508b. The first half 508a and second half 508b are connected by a connecting portion 509 which is a flexible so that the first half 508a may be brought into contact with and aligned with the second half 508b. In this configuration, the adaptor sliders 508 also include a tab 507 for assisting in the aligning of the first half 508a and second half 508b and/or providing a clasp for securing the union between the first half 508a and the second half 508b.

In order to install the adaptive sliders 508, 510, and 512, the user may place the cords 506a and 506b inside one half of the adaptor slider 508b and then close the other half of the adaptor slider 508a around the cords 506a and 506b so that the two halves of the adaptor slider 508a and 508b are aligned and enclose the cords 506a and 506b. Then, in one embodiment, the tab 507 may then be used to fasten the two halves of the adaptor slider 508a and 508b. Once the adaptor sliders 508, 510, and 512 have been installed, the user may slide the adaptor sliders 508, 510, and 512 along the cords 506a and 506b in order to achieve the desired cord configuration.

With the benefit of the present disclosure, one of skill in the art can appreciate other configurations to attach the sliders 508, 510, and 512 to the cords. In one embodiment, the sliders 508, 510 and 512 may attach in a manner such that the sliders are semi-permanent in the sense that once connected, they are very difficult to disconnect. In another embodiment, the sliders 508, 510, and 512 may apply force to the cords 506a and 506b such that the sliders are not configured to slide, but are fixed in position. They may crimp the cords without interfering with the electrical function of the cords. In this case, the sliders can be repositioned, however, for example by opening the sliders and repositioning them.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A headset comprising:
a cord having a plug on a first end and a first lead cord and a second lead cord on a second end, wherein the first lead cord is connected to a first speaker and the second lead cord is connected to a second speaker; and
a plurality of sliders, each slider having an opening formed therein, wherein the first and second lead cords each pass through each of the plurality of sliders;
wherein a position of each slider is adjustable along a length of the first and second lead cords.

2. The headset of claim 1, wherein the cord, first lead cord, and second lead cord are covered by a nylon material.

3. The headset of claim 1, wherein the plurality of sliders includes three sliders.

4. The headset of claim 1, further comprising a removable button loop disposed on the second end of the cord where the cord is connected to a first lead cord and a second lead cord which is capable of anchoring the headset to a user's shirt.

5. The headset of claim 1, wherein the first lead cord includes controller which is capable of controlling one or more functions of a device attached to the plug.

6. The headset of claim 5, wherein the controller further comprises a microphone capable of capturing an audio signal and sending it to the device.

7. The headset of claim 1, wherein the cord further comprises a volume controller capable of controlling the volume of the first and second speakers.

8. The headset of claim 1, wherein the plurality of sliders are capable of being positioned on the first and second lead cord so as to anchor the headset on a user during use.

9. The headset of claim 1, further comprising an anchoring bead having an opening formed therein, wherein the first and second lead cords each pass through the anchoring bead, and wherein the anchoring bead is permanently positioned on the first and second lead cords.

10. The headset of claim 9, wherein the plurality of sliders are capable of being positioned on the first and second lead cord so as to be used in association with the anchoring bead to anchor the headset on a user during use.

11. An adaptor set for a headset including a first lead cord connected to a first speaker, a second lead cord connected to a second speaker, and a plug connected to the first lead cord and second lead cord, the adaptor set comprising:
a plurality of sliders, each slider having an enclosing portion with an opening formed therein, each slider being capable of being installed so as to enclose the first and second lead cords in the opening portion of the enclosing portion so that the first and second lead cords pass through each of the plurality of sliders;
wherein a position of each slider is installable and adjustable along a length of the first and second lead cords.

12. The adaptor set of claim 11, wherein the adaptor set includes three sliders.

13. The adaptor set of claim 11, where one of the sliders comprises a removable button loop which is capable of anchoring the headset to a button of a user's shirt.

14. The adaptor set of claim 11, wherein the plurality of sliders are capable of being positioned on the first and second lead cord so as to anchor the headset on a user during use.

15. The adaptor set of claim 11, further comprising an anchoring bead having an having an enclosing portion with an opening formed therein, the anchoring bead being capable of being installed so as to enclose the first and second lead cords in the opening portion of the enclosing portion so that the first and second lead cords pass through the anchoring bead, wherein the first and second lead cords each pass through the anchoring bead, and wherein the anchoring bead is permanently positioned on the first and second lead cords.

16. The adaptor set of claim 15, wherein the plurality of sliders are capable of being positioned on the first and second lead cord so as to be used in association with the anchoring bead to anchor the headset on a user during use.

17. A kit for anchoring the headset of an electronic device to a user, the kit comprising:
a plurality of sliders, each slider having an enclosing portion with an opening formed therein, each slider being capable of being installed on a headset including a plug, a first and second lead cord attached to the plug, and a first and second speaker attached to the first and second lead cord, respectively, each slider being capable of being installed by a user so as to enclose the first and second lead cords in the opening portion so that the first and second lead cords pass through each of the plurality of sliders, wherein a position of each slider is installable and adjustable along the length of the first and second lead cords;
a user instruction, including instructions on how to install the plurality of sliders and instructions on how to position the plurality of sliders and headset on a user so as to anchor the headset to a user during use; and
a package having at least one enclosure for enclosing the plurality of sliders and the user instruction.

18. The kit of claim 17, further comprising an anchoring bead having an having an enclosing portion with an opening formed therein, the anchoring bead being capable of being installed so as to enclose the first and second lead cords in the opening portion of the enclosing portion so that the first and second lead cords pass through the anchoring bead, wherein the first and second lead cords each pass through the anchoring bead, wherein the anchoring bead is permanently positioned on the first and second lead cords, and wherein the enclosure of the package is further capable of enclosing the anchoring bead.

19. The kit of claim 18, wherein the user instructions further comprise instructions on how to install the anchoring bead on the headset and instructions on how to position the anchoring bead and plurality of sliders on the headset so as to anchor the headset to a user during use.

20. The kit of claim 17, wherein the kit includes three sliders.
